(19) United States
(12) Patent Application Publication
(10) Pub. No.: US 2007/0080170 A1
(43) Pub. Date: Apr. 12, 2007

(54) Condiment dispenser

(76) Inventor: Atanu Saha, Purchase, NY (US)

Correspondence Address: OSTROLENK FABER GERB & SOFFEN, 1180 AVENUE OF THE AMERICAS, NEW YORK, NY, 100368403, US

(21) Appl. No.: 11/247,536

(22) Filed: Oct. 11, 2005

(51) Int. Cl. A47G 19/00; B67D 5/06

(52) U.S. Cl. 222/142.1; 222/144.5

(57) ABSTRACT

A condiment dispenser includes one or more condiment chambers for holding condiments. Each condiment chamber is connected to a common discharge chamber or to a respective discharge chamber, the discharge chamber(s) having an outlet for dispensing condiments from the condiment chamber(s). Each connection may be formed through a respective tube. A flow control mechanism may control the flow from a condiment chamber to a discharge chamber. The mechanism may be a dial that is operable to compress and decompress the tube. The dial may move between numerous positions and retain any position between uses. A dispersing element may be positioned respective to the outlet of a discharge chamber to control the dispensing and dispersing of condiments. In an example operation, the flow control mechanism(s) are adjusted to a desired flow and the dispenser is inverted, causing condiment(s) to flow from the condiment chamber(s) and into the discharge chamber(s), where the condiments are dispensed and dispersed.

### BACKGROUND OF THE INVENTION

1. Field of the Invention

The present invention relates to a condiment dispenser, and in particular, to a condiment dispenser with one or more condiment chambers, each with a flow control mechanism, and with one or more outlets through which the condiments are dispensed.

2. Description of the Art

Condiment dispensers for holding and dispensing condiments, such as salt and pepper, are well known. Some condiment dispensers hold only a single condiment and other condiment dispensers hold and dispense multiple condiments. As is known, some condiment dispensers also include a flow control mechanism. These mechanisms assist a user in dispensing a desired amount of a condiment. When used on dispensers that hold multiple condiments, the flow control mechanisms may also allow a user to select and dispense one or more desired condiments while preventing the other condiments from being dispensed.

These prior art condiment dispensers have several problems. For example, condiment dispensers typically use a plurality of perforations in a cap or lid to dispense the condiments. These perforations help control the rate at which the condiments are dispensed and also assist in dispersing the condiments. Condiments, such as salt, however, will often collect within the perforations causing the perforations to clog.

Problems also exist with prior flow control mechanisms. For example, flow control mechanisms are typically designed such that the condiments make actual contact with the mechanisms. Over time, the condiments can collect within the mechanisms causing the mechanisms to clog and become difficult to use.

Notably, flow control mechanisms are often spring activated such that a user must physically manipulate the mechanisms during each use in order to dispense the condiments. Thereafter, the flow control mechanisms move back to a closed position. These spring-activated mechanisms can be problematic for several reasons. For example, even if a user has a desired setting, the user must always reset the flow control mechanism to that setting prior to each use. In addition, these spring activated mechanisms can be difficult to use given that a user must set and maintain the mechanisms at a desired setting while at the same time shaking the dispenser. For condiment dispensers that hold multiple condiments, the difficulty increases when a user wishes to simultaneously dispense multiple condiments. Here, the user must set and maintain each mechanism at possibly different settings while at the same time shaking the dispenser.

### SUMMARY

Accordingly, it is desirable to provide a condiment dispenser that overcomes the above and other disadvantages of the prior art. According to an example embodiment of the present invention, a condiment dispenser includes a plurality of isolated condiment chambers, such as two chambers, each of which stores/maintains a separate condiment, for example. The condiment dispenser also includes a common discharge chamber that forms a dispensing outlet of one or more openings through which condiments from each of the condiment chambers are dispensed. Specifically, each condiment chamber has a corresponding tube that connects the condiment chamber to the discharge chamber. Upon inverting/tilting the condiment dispenser, for example, condiments flow from each condiment chamber, through the respective tubes, and into the common discharge chamber where the condiments are dispensed through the dispensing outlet and subsequently from the condiment dispenser.

According to example embodiment of the present invention, a dispersing element may be positioned at a spaced distance above and over the discharge chamber and in particular, above and over the dispensing outlet, although other configurations are possible. In this way, the discharge chamber and the dispersing element form a gapped outlet (dispensing gap). By positioning the dispersing element in this fashion, the dispersing element operates as a flow mechanism that controls the rate at which condiments are discharged from the discharge chamber and thereby from the condiment dispenser. Specifically, as the condiment dispenser is tilted or inverted in order to dispense condiments, the condiments enter the discharge chamber and subsequently exit the chamber through the dispensing outlet. As the condiments exit through the outlet, the condiments largely bounce up and against the dispersing element. As this occurs, the condiments largely deflect back into the discharge chamber, with only a controlled amount of the condiments subsequently passing through the dispensing gap and thereby from the condiment dispenser. As such, the dispersing element interferes with and deflects the flow of the condiments through the dispensing outlet, thereby controlling the rate at which the condiments are dispensed from the discharge chamber and more particularly, from the condiment dispenser. In addition, the dispersing element may also extend beyond the perimeter of the discharge chamber. In this way, once the condiments pass through the dispensing gap, the dispersing element causes the condiments to flow outward and around the dispersing element while exiting the condiment dispenser, thereby causing the condiments to disperse outward, assisting in the spreading of the condiments. As such, according to an embodiment of the present invention, the condiment dispenser avoids the use of perforations, which typically clog, in order to dispense and disperse condiments.

According to an example embodiment of the present invention, each condiment chamber may also have a corresponding flow control mechanism that controls the rate at which a condiment flows through the chamber's respective tube and into the discharge chamber. Although the flow control mechanisms may be a single mechanism such that the setting of one mechanism affects the setting of the others, preferably the flow control mechanisms are independent mechanisms such that each mechanism operates independently of the others.

According to an example embodiment of the present invention, each flow control mechanism for a given condiment chamber includes, for example, a pressing block and a rotational dial with a notched edge. For each condiment chamber, the respective tube is positioned such that the body of the tube passes between the notched edge and the pressing block of the corresponding flow control mechanism. Preferably, each tube is formed from an elastic and flexible material such that the shape of each tube may be deformed and thereafter return to its original shape. Accordingly, each flow control mechanism operates by rotating the dial such that notched edge presses the tube against the pressing block, thereby compressing the size of the opening/passage in the tube and decreasing the flow of a condiment through the tube. Similarly, as the dial is rotated so as to move the notched edge away from the pressing block, the tube naturally decompresses, thereby causing the size of the tube opening to increase back towards its original size and thereby increasing the flow of a condiment through the tube. Preferably, each flow control mechanism is operable to vary the rate at which a condiment flows through a tube and is also operable to completely seal-off a condiment chamber from the discharge chamber.

According to an example embodiment of the invention, the rotational dial for each flow control mechanism is configured to resistively rotate, for example, such that each dial can be individually moved to any flow position and thereafter retain that position. In this way, a user can individually configure each flow control mechanism to a desired setting and then dispense the condiments without the difficulty of trying to maintain the settings. Similarly, a user can individually configure each flow control mechanism to a desired setting and have each mechanism retain its respective setting between uses.

In lieu of rotational dials to compress the tubes, any mechanism known in the art can be used to vary the size of the tube openings. For example, each flow control mechanism may be a spring-activated button, or the like, that when pressed, compresses a tube and that decompresses the tube when released.

In an example embodiment of the invention, condiments flow through the tubes to the discharge chamber and never contact the flow control mechanisms. As result, the condiments are not able to collect upon the flow control mechanisms and interfere with the operation of the mechanisms.

In an example method according to an example embodiment of the invention, a user of the condiment dispenser fills each condiment chamber with a different condiment, such a salt and pepper (assuming the dispenser includes only two condiment chambers). For each use thereafter, the user of the condiment dispenser may manipulate the flow control mechanisms to desired settings such that either one condiment or a combination of both condiments are dispensed and such that a desired amount of each condiment is dispensed. Thereafter, the user tilts and possibly inverts the condiment dispenser, shaking or moving the dispenser in a conventional manner. Assuming the user configures the flow control mechanisms to dispense both condiments, upon inverting/moving the dispenser, each condiment flows from its respective condiment chamber, through its respective tube, and into the discharge chamber, with the flow control mechanisms affecting the flow of each condiment into the chamber. Notably, because the condiments enter the common discharge chamber prior to being discharged, the condiments can intermix within the chamber resulting in the condiments being more evenly applied to food. Once the condiments are in the discharge chamber, they are thereafter dispensed through the dispensing gap and dispersed by the dispersing element.

According to another example embodiment of the present invention, a condiment dispenser includes multiple condiment chambers and a common discharge chamber with a dispensing gap formed by a dispersing element, as described above. However, according to this embodiment of the invention, the condiment dispenser is not limited to the use of interconnecting tubes and rotary dial flow control mechanisms, for example. Rather, any mechanism known in the art may be used to interconnect the discharge chamber and the condiment chambers and to control the flow between the chambers. In addition, the condiment dispenser does not need to include flow control mechanisms.

According to another example embodiment of the present invention, a condiment dispenser includes multiple condiment chambers. Preferably, each chamber has a corresponding/dedicated discharge chamber providing a dedicated dispensing outlet and a dedicated dispensing gap. As an example, a separate dispersing element may be positioned relative to each discharge chamber/dispensing outlet to provide the dispensing gaps or, alternatively, a common dispersing element may be positioned relative to each discharge chamber/dispensing outlet to provide the dispensing gaps. Here, the flow control mechanisms and the interconnection between the condiment chambers and the discharge chambers may resemble the rotary dial mechanisms and the flexible tubes, for example, described above. Nonetheless, any mechanism known in the art may be used for interconnecting the discharge chambers and the condiment chambers and for controlling the flow between the chambers. Similarly, according to this embodiment of the invention, the condiment dispenser does not need to include flow control mechanisms.

According to another example embodiment of the present invention, a condiment dispenser includes a single condiment chamber for storing a condiment. This condiment chamber is connected to a discharge chamber that forms a dispensing outlet. A dispersing element is positioned relative to the discharge chamber and dispensing outlet to form a dispensing gap, similar to above. Any mechanism known in the art may be used to interconnect the discharge chamber and the condiment chamber and for controlling the flow between the chambers, including a flexible tube and rotary dial, for example, as described above. Again, according to this embodiment of the invention, the condiment dispenser does not need to include a flow control mechanism.

According to another example embodiment of the present invention, a condiment dispenser includes multiple condiment chambers, a common discharge chamber, tubes that interconnect the condiment chambers to the discharge chamber, and flow control mechanisms, such as rotary dials, that compress the tubes to vary the size of the tube openings, as described above. Preferably, the condiment dispenser does not include a dispersing element positioned over a discharge chamber and dispensing outlet to thereby form a dispensing gap. Rather, according to this embodiment of the invention, any mechanism known in the art for dispensing and dispersing the condiments from the discharge chamber may be used, such as, for example, a plurality of openings or perforations.

According to another example embodiment of the present invention, a condiment dispenser includes multiple condiment chambers, each with a corresponding and dedicated discharge chamber. Each condiment chamber is connected to its discharge chamber through a flexible tube and a flow control mechanism, such as a rotary dial that is operable to compress the tube to vary the size of the tube opening, as described above. Here, again, any mechanism known in the art for dispensing and dispersing the condiments from the discharge chambers may be used.

According to a further example embodiment of the present invention a condiment dispenser includes a single condiment chamber for holding a single condiment, for example. Here, a tube interconnects the condiment chamber to the discharge chamber and a flow control mechanism, such as a rotary dial, compresses the tube to vary the size of the tube opening, as similarly described above. Again, any mechanism known in the art for dispensing and dispersing the condiments from the discharge chamber may be used.

Other features and advantages of the present invention will become apparent from the following description of the invention, which refers to the accompanying drawings.

### BRIEF DESCRIPTION OF THE DRAWINGS

FIG. 1 shows a front plan view of an example condiment dispenser according to the present invention.

FIG. 1A shows a cross sectional front view of the example condiment dispenser of FIG. 1 and in particular, shows example internal mechanisms of the condiment dispenser according to the present invention.

FIG. 1B shows a top plan view of the example condiment dispenser of FIG. 1.

FIG. 1C shows a bottom plan view of the example condiment dispenser of FIG. 1.

FIG. 1D shows a cross sectional top view of the example condiment dispenser shown by FIG. 1A and in particular, shows example condiment chambers within the condiment dispenser according to the present invention.

FIG. 1E shows a front view of an example interconnection between condiment chambers and a discharge chamber according to the present invention.

FIG. 1F shows a cross sectional top view of the example condiment dispenser shown by FIG. 1A and in particular, shows an example flow control mechanism according to the present invention.

FIGS. 1G and 1H show a portion of the example flow control mechanism shown by FIG. 1F, FIGS. 1G and 1H showing the mechanism in an open and closed position, respectively, according to the present invention.

FIG. 11 shows a front view of the flow control mechanism shown by FIGS. 1G and 1H, FIG. 11 showing the mechanism in a partially closed position.

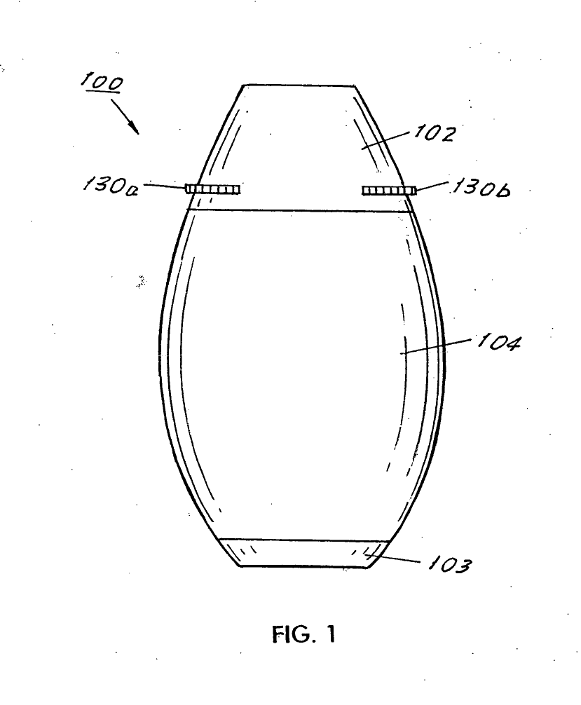

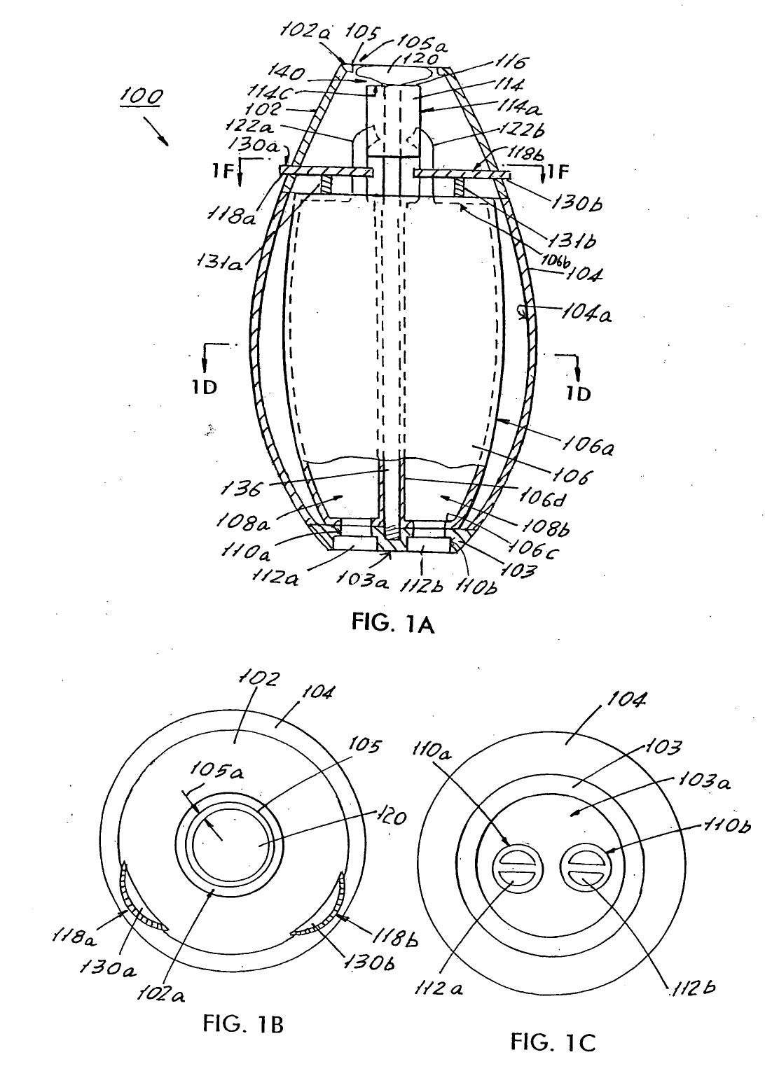

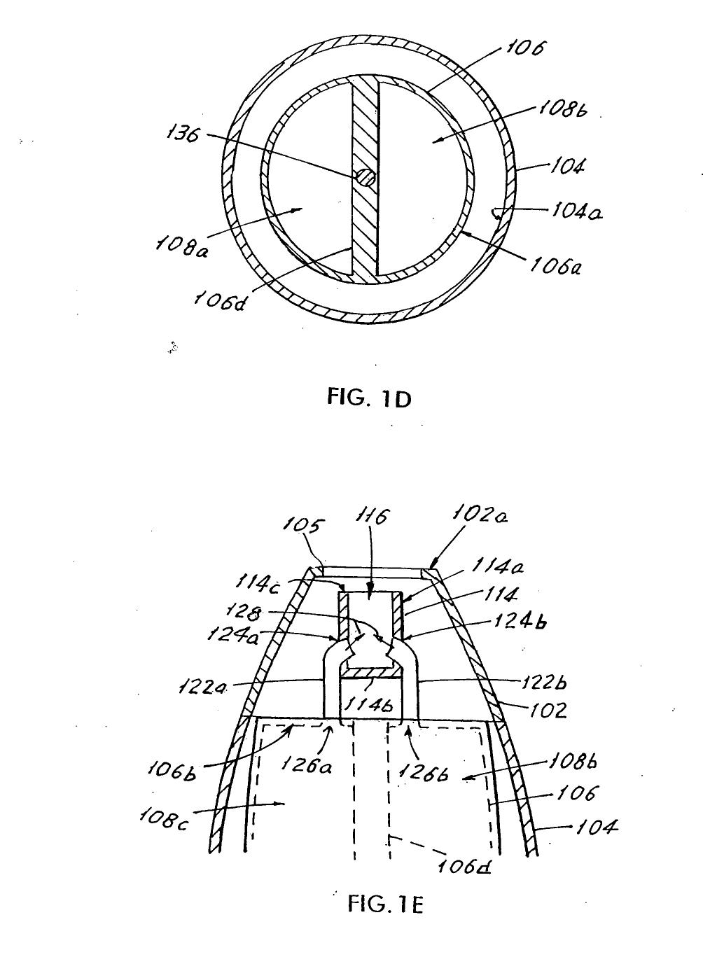

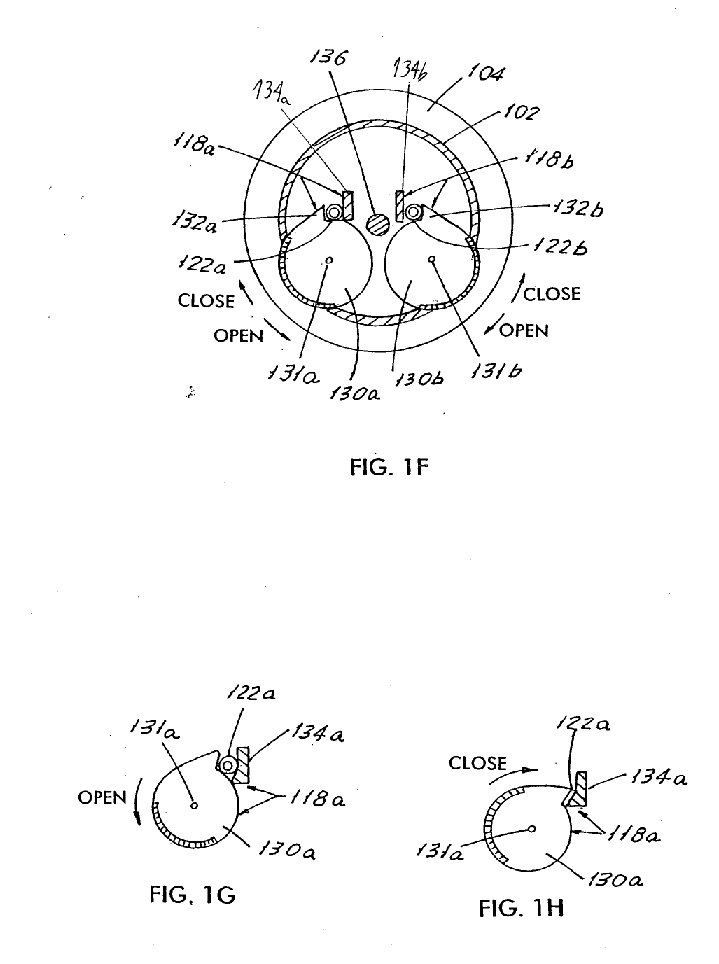

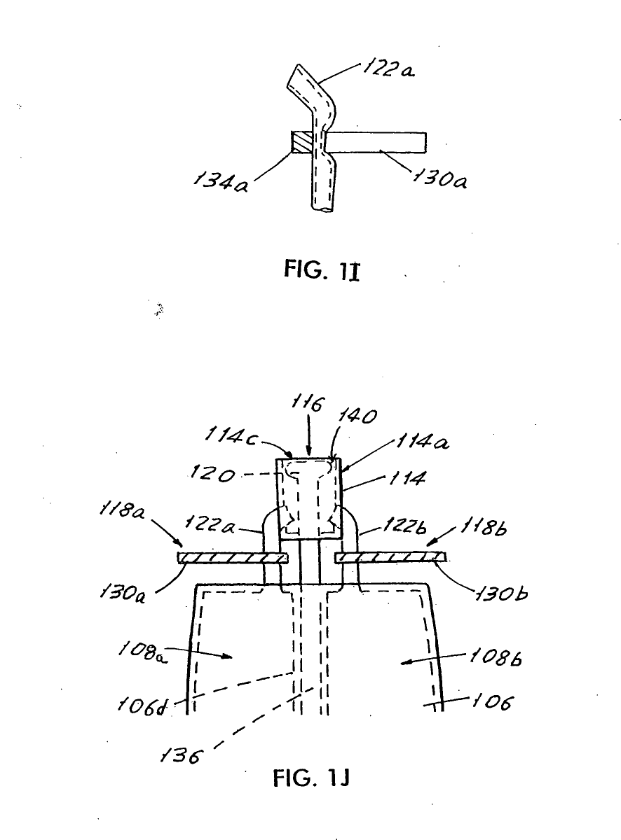

FIG. 1J shows a front view of an example condiment dispensing and dispersing mechanism according to the present invention.

FIG. 2A shows a cross sectional front view of an example condiment dispenser according to the present invention and in particular, shows example internal mechanisms of the condiment dispenser.

FIG. 2B shows a cross sectional top view of the example condiment dispenser shown by FIG. 2A and in particular, shows an example flow control mechanism and an example interconnection between condiment chambers and a discharge chamber according to the present invention.

FIG. 3 shows a cross sectional front view of an example condiment dispenser according to the present invention and in particular, shows example internal mechanisms of the condiment dispenser.

FIG. 4 shows a cross sectional front view of an example condiment dispenser according to the present invention and in particular, shows example internal mechanisms of the condiment dispenser.

FIG. 5A shows a cross sectional front view of an example condiment dispenser according to the present invention and in particular, shows example internal mechanisms of the condiment dispenser.

FIG. 5B shows a top plan view of the example condiment dispenser of FIG. 5A and in particular, shows an example dispensing and dispersing mechanism according to the present invention.

FIG. 6 shows a cross sectional front view of an example condiment dispenser according to the present invention and in particular, shows example internal mechanisms of the condiment dispenser.

FIG. 7 shows a cross sectional front view of an example condiment dispenser according to the present invention and in particular, shows example internal mechanisms of the condiment dispenser.

### DESCRIPTION OF THE EMBODIMENTS

Referring to FIG. 1, there is illustrated a front view of an example condiment dispenser 100 according to the present invention. Condiment dispenser 100 includes a case 104, a cover 102 attached at the top side of a case 104, and a base 103 attached at the bottom side of case 104, for example, although dispenser 100 is not limited to this form. Case 104, cover 102, and base 103 may be formed from any suitable material known in the art (e.g., plastic, metal, wood, etc.) and may each be formed of the same material or of different materials, such as a combination of plastic and metal.

Referring now to FIG. 1A, there is shown a cross sectional side view of dispenser 100, with a portion of case 104, cover 102, and base 103 removed. As shown, dispenser 100 also includes a plurality of condiment chambers, such as two or more condiment chambers, like chambers 108a and 108b, disposed within case 104, for example. For description purposes, condiment dispenser 100 will be described as having two condiment chambers 108a and 108b. Nonetheless, one skilled in the art will recognize that condiment dispenser 100 is not limited to two condiment chambers and may include more than two chambers. Condiment chambers 108a and 108b are individual and isolated chambers, each of which is intended to hold a condiment, preferably of different types, such as salt and pepper. As indicated, the chambers are isolated so that the condiment in one chamber does not mix with the condiment in the other chamber.

Condiment dispenser 100 also includes discharge chamber 114, flow control mechanisms 118a and 118b, dispersing element 120, and tubes 122a and 122b, each of which is housed within cover 102, for example. Discharge chamber 114 is an open chamber that includes a side wall 114a and bottom wall 114b , for example, and an opening at top side (top end) 114c through which condiments are dispensed from the discharge chamber as described below. (Hereinafter, the opening at top end 114c of discharge chamber 114 will be referred to as a dispensing outlet 116 and is more clearly shown in FIG. 1E). Tubes 122a and 122b are situated between and interconnect discharge chamber 114 and condiment chambers 108a and 108b, respectively, such that tube 122a forms a closed path from condiment chamber 108a to discharge chamber 114 and tube 122b forms a closed path from condiment chamber 108b to discharge chamber 114. Accordingly, when condiment dispenser 100 is tilted or inverted, for example, in order to dispense condiments, the condiments in condiment chambers 108a and 108b may flow through their respective tubes 122a/122b and into discharge chamber 114. Thereafter, the condiments are dispensed out of the discharge chamber through the dispensing outlet 116 and are subsequently discharged from condiment dispenser 100, as further described below.

Flow control mechanisms 118a and 118b are positioned between discharge chamber 114 and condiment chambers 108a and 108b, respectively, with flow control mechanism 118a controlling the rate at which a condiment flows through tube 122a and with flow control mechanism 118b controlling the rate at which a condiment flows through tube 122b. Preferably, flow control mechanism 118a is operable to control the flow rate through tube 122a such that a condiment in condiment chamber 108a can freely flow to discharge chamber 114 and such that the condiment in this chamber can be sealed off from discharge chamber 114. Similarly, flow control mechanism 118b is preferably operable to control the flow rate through tube 122b such that a condiment in condiment chamber 108b can freely flow to discharge chamber 114 and such that the condiment in this chamber can be sealed off from discharge chamber 114. Preferably, each flow control mechanism is also operable to vary the flow rate that a condiment flows from the respective condiment chamber to the discharge chamber. Although flow control mechanisms 118a and 118b may be a single mechanism such that the setting of one mechanism affects the setting of the other, flow control mechanisms 118a and 118b are preferably independent mechanisms, as shown in FIG. 1A, such that one mechanism operates independently of the other. In this way, a user of condiment dispenser 100 can configure flow control mechanisms 118a and 118b to allow one condiment or combinations of multiple condiments to flow into discharge chamber 114 and can further configure flow control mechanisms 118a and 118b to control the amount of each condiment that flows into discharge chamber 114.

Referring now to FIG. 1A and to FIG. 1B, which shows a top view of condiment dispenser 100, formed within the top end 102a of lid 102 is an opening 105, for example, for dispensing condiments from the condiment dispenser. Situated within opening 105, for example, and at spaced distance above/over the top end 114c of discharge chamber 114, for example, is dispersing element 120. Dispersing element 120 is a disc or plate, for example, that preferably has no holes or perforations formed therein. The dispersing element is situated relative to the perimeter of opening 105, for example, such that the dispersing element and opening form a gap 105a, for example. Dispersing element 120 is also positioned to form a gapped opening/outlet (or dispensing gap) 140 with the perimeter of discharge chamber 114 at top end 114c, for example. Dispensing gap 140 may extend around the complete perimeter of discharge chamber 114.

By positioning dispersing element 120 in the above fashion, the dispersing element effectively operates as an additional flow mechanism that controls the rate at which condiments are discharged from discharge chamber 114, and thereby from condiment dispenser 100. In addition, the dispersing element also operates as a dispersing mechanism that assists in the spreading of condiments. Specifically, as indicated above, as condiment dispenser 100 is tilted or inverted in order to dispense condiments, the condiments enter discharge chamber 114 and subsequently exit the chamber through dispensing outlet 116. As the condiments exit through outlet 116, the condiments largely bounce up and against the bottom side surface of dispersing element 120. As this occurs, the condiments largely deflect back into discharge chamber 114, with only a controlled amount of the condiments passing through the dispensing gap 140 and subsequently through gap 105a/opening 105. As such, dispersing element 120 interferes with and deflects the flow of the condiments through dispensing outlet 116, thereby controlling the rate at which the condiments are dispensed from the discharge chamber and more particularly, from the condiment dispenser. In addition, once the condiments pass through dispensing gap 140 towards opening 105, dispersing element 120 also causes the condiments to flow outward and around the dispersing element while exiting through opening 105. In this way, dispersing element 120 also causes the condiments to disperse outward from condiment dispenser 100, assisting in the spreading of the condiments.

In an example method according to an embodiment of the present invention, a user of condiment dispenser 100 fills each condiment chamber 108a and 108b with a different condiment, such a salt and pepper. For each use thereafter, the user of condiment dispenser 100 may manipulate each flow control mechanism 118a and 118b to a desired setting such that either one or a combination of both condiments are dispensed. In addition, the user may configure the flow control mechanisms to set a flow rate such that a desired amount of each condiment is dispensed. Thereafter, the user tilts and possibly inverts condiment dispenser 100, shaking or moving the dispenser in a conventional manner. Assuming the user configures the flow control mechanisms 118a and 118b to dispense both condiments, upon inverting/moving the dispenser, each condiment flows from its respective condiment chamber 108a/108b, through its respective tube 122a/122b, and into discharge chamber 114, with flow control mechanisms 118a and 118b affecting the flow of each condiment into chamber 114. Because the condiments enter the common discharge chamber 114 prior to being discharged, the condiments intermix within the chamber resulting in the condiments being more evenly applied to food. Once the condiments are in discharge chamber 114, they are thereafter dispensed through dispensing gap 140 and dispersed by dispersing element 120 through opening 105.

Reference will now be made in greater detail to each of the components of condiment dispenser 100. Beginning with condiment chambers 108a and 108b, in general, these chambers may be formed in any suitable manner. As an example and as illustrated in FIG. 1A and FIG. 1D, which is a cross sectional top view of condiment dispenser 100, condiment chambers 108a and 108b may be formed from a single chamber 106 that includes a side wall 106a, a top wall 106b, and a bottom wall 106c. Alternatively, rather than chamber 106 having a sidewall 106a for example, the inner wall 104a of body 104 may form the sidewall of the chamber. The bottom wall 106c of chamber 106 may sit on or be connected to base 103, for example, as shown in FIG. 1A. Alternatively, chamber 106 may seat within base 103 and in addition, may be situated such that bottom wall 106c of the chamber and the bottom wall 103a of base 103 are one in the same. Here, chamber 106 may form, for example, the bottom side of condiment dispenser 100.

Within chamber 106 is partition 106d, for example, that subdivides the chamber into individual and isolated condiment chambers 108a and 108b. Notably, if condiment dispenser 100 includes more than two condiment chambers, chamber 106 may include more than one partition. Partition 106d may reside in the center of chamber 106, thereby forming condiment chambers 108a and 108b of equal size, as illustrated in FIGS. 1A and 1D. Alternatively, partition 106d may reside off-center, thereby forming condiment chambers of different sizes. In general, chamber 106 may be formed from any suitable material known in the art, such as plastic or metal. Notably, rather than forming chambers 108a and 108b from a single chamber 106, they may be formed as individual chambers.

Referring now to FIG. 1A and FIG. 1C, which is a bottom view of condiment dispenser 100, within the bottom wall 103a of base 103 and the bottom wall 106c of chambers 108a and 108b are two holes/openings 110a and 110b, for example, that provide access to respective ones of condiment chambers 108a and 108b. Each of these holes has a corresponding removable cap 112a and 112b. As an example, caps 112a and 112b may be plugs made of plastic or rubber, for example, that snuggly fit within holes 110a and 110b, thereby sealing chambers 108a and 108b. As another example, holes 110a and 110b and caps 112a and 112b may each be threaded such that the caps screw into the holes. Nonetheless, any mechanism known in the art for providing removable caps that seal the chambers can be used. As is readily understood, by removing caps 112a and 112b, condiment chambers 108a and 108b can be filled with condiments and thereafter resealed.

Referring now to FIG. 1E, discharge chamber 114 and tubes 122a and 122b are shown in greater detail (note that the flow control mechanisms 118a and 118b and dispersing element 120 are not shown in this FIG.). As indicated, discharge chamber 114 is an open chamber. As shown in FIG. 1E, discharge chamber 114 may have a cylindrical shape with a sidewall 114a, a bottom wall 114b, and an opening at top side 114c. Nonetheless, chamber 114 may have other shapes, such as a cube or rectangle, with an open topside. In addition, while discharge chamber 114 is illustrated as having side and bottom walls, the chamber may also have a sphere or inverted cone like shape with an open top side, for example, thereby having one uniform wall. For description purposes, discharge chamber 114 will be illustrated as having a cylindrical shape. As indicated, the perimeter of discharge chamber 114 at top side 114c forms an opening or dispensing outlet 116 through which condiments are dispensed from the chamber. In general, discharge chamber 114 may be formed from any suitable material known in the art, such as metal or plastic.

Overall, any method known in the art for interconnecting discharge chamber 114 to condiment chambers 108a and 108b through tubes 122a and 122b may be used. As an example, two openings 124a and 124b may be formed preferably within side wall 114a of discharge chamber 114, although openings 124a and 124b may be formed elsewhere in discharge chamber 114, such as in bottom wall 114b. Similarly, within top wall 106b of chamber 106, for example, two openings 126a and 126b may be formed, each corresponding to and providing access to a respective condiment chamber 108a and 108b. Tube 122a may then be interconnected between opening 124a and opening 126a and tube 122b may be interconnected between opening 124b and 126b. In this way, when condiment dispenser 100 is tilted or inverted, for example, condiments can flow from condiment chambers 108a and 108b to discharge chamber 114 through tubes 122a and 122b, respectively. Preferably, tubes 122a and 122b are formed from an elastic and flexible material, like rubber, plastic, silicon, or the like such that the shape of each tube may be deformed and thereafter return to its original shape.

As indicated, tubes 122a and 122b preferably connect to discharge chamber 114 at sidewall 114a. In addition, tubes 122a and 122b are preferably positioned at discharge chamber 114 such that an opening in each tube is angled upward within chamber 114, as illustrated by arrows 128 in FIG. 1E. By connecting the tubes to discharge chamber 114 at side wall 114a and by angling the tubes upward as just described, if a user does not completely dispense condiments from discharge chamber 114, any remaining condiments left in the discharge chamber when condiment dispenser 100 is up-righted will tend to fall towards the bottom wall 114b of the chamber rather than back into tubes 122a and 122b and subsequently into chambers 108a and 108b. As a result, condiments are less likely to become intermixed within the condiment chambers 108a and 108b. Nonetheless, tubes 128a and 128b do not need to be angled in the described fashion and again, may connect to discharge chamber 114 at bottom wall 114b.

Notably, while condiment dispenser 100 is described as having a discharge chamber 114, the dispenser does not need to include this chamber. Specifically, discharge chamber 114 needs to only have a size and shape sufficient to form dispensing outlet 116 and sufficient to provide connection to condiment chambers 108a and 108b (such as through tubes 122a and 122b) such that these condiment chambers can communicate with dispensing outlet 116.

Referring now to FIG. 1A and FIG. 1F, which is a cross sectional top view of condiment dispenser 100, flow control mechanisms 118a and 118b are illustrated in greater detail (note that FIG. 1F does not show discharge chamber 114 and dispersing element 120). According to an example embodiment of the present invention, flow control mechanisms 118a and 118b each includes a pressing block 134a/134b and a rotational dial 130a/130b with a notched edge 132a/132b, for example. For each flow control mechanism 118a and 118b, dial 130a/b is positioned horizontally within condiment dispenser 100, as illustrated in FIGS. 1, 1A, and 1F, such that the body of each tube 122a/122b passes between notched edge 132a/b and pressing block 134a/b. In addition, each dial 130a/b is configured to rotate (e.g., on a pin 131a/131b) and preferably extends beyond cover 102 such that a user may manually move/rotate the dial.

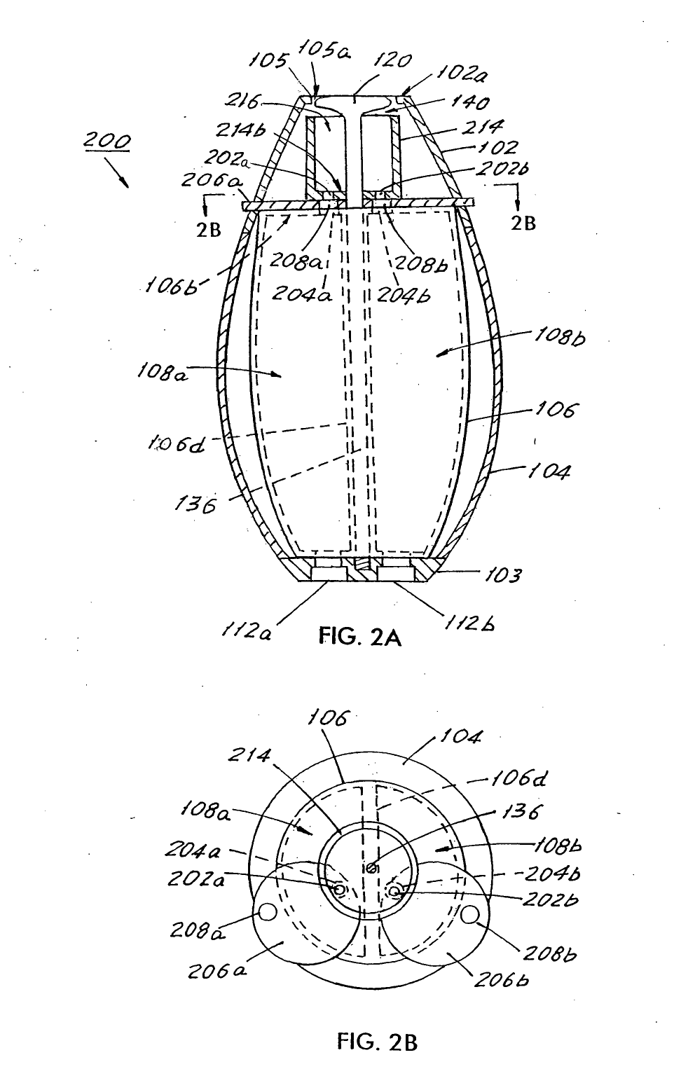

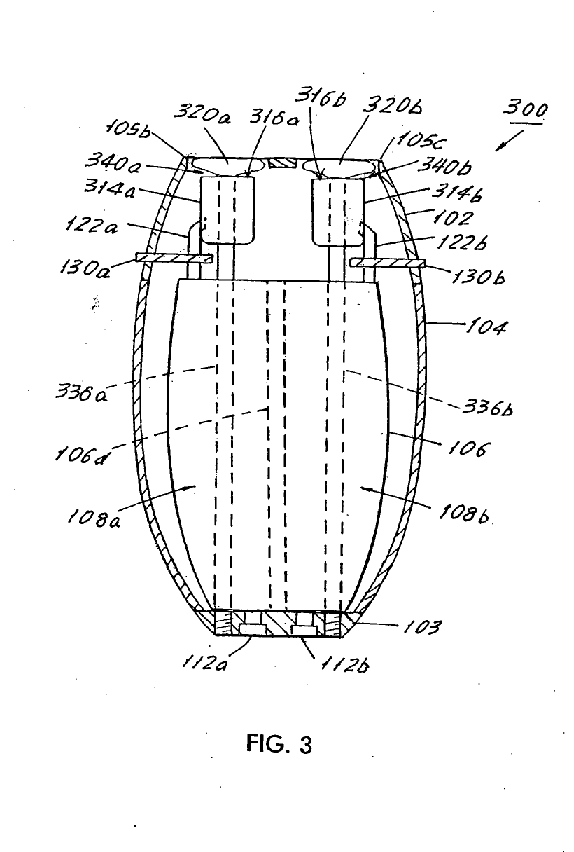

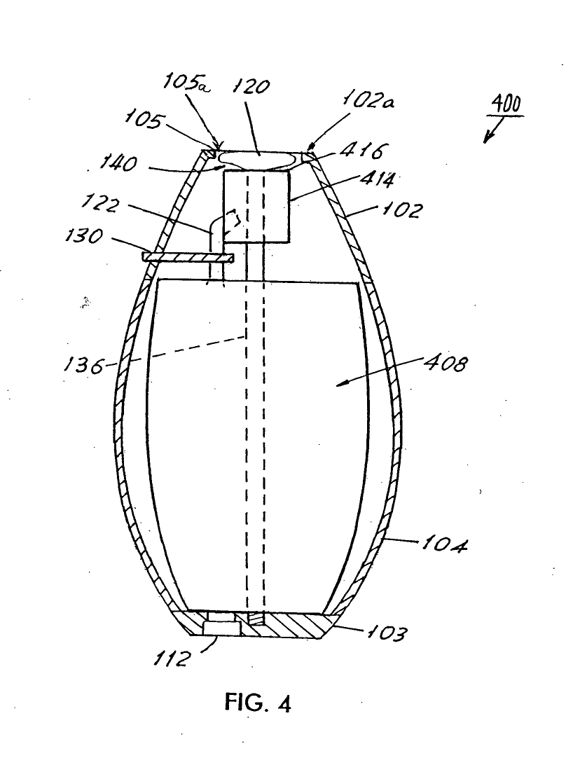

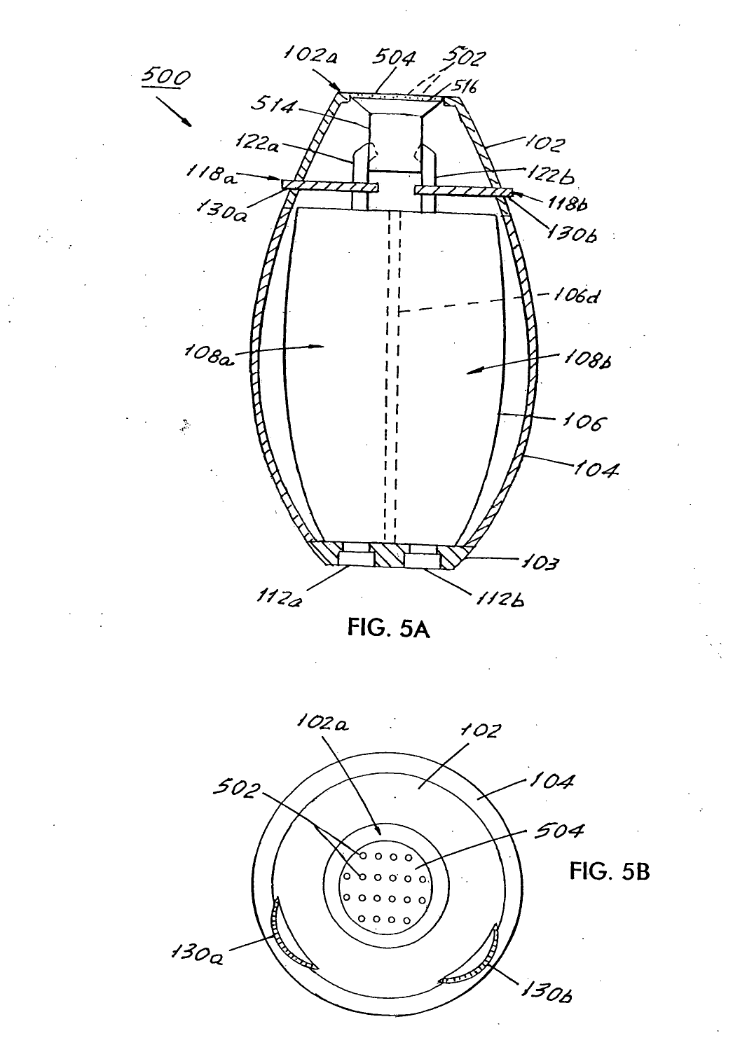

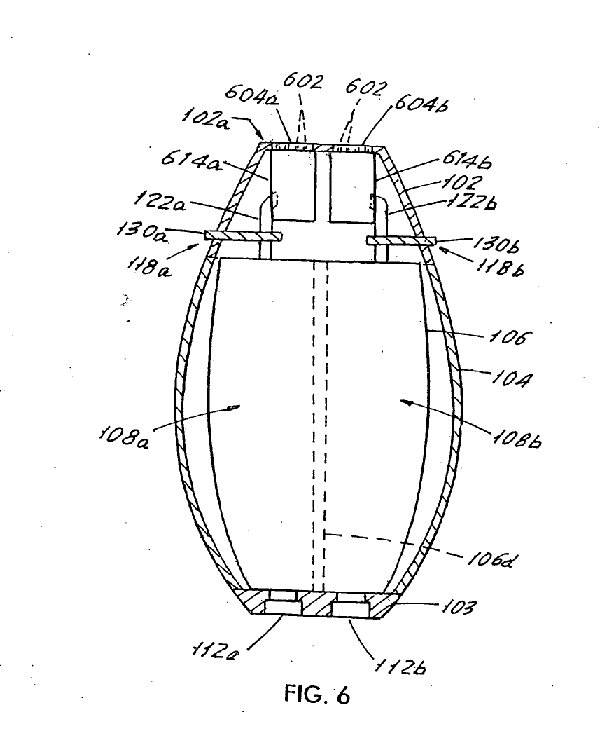

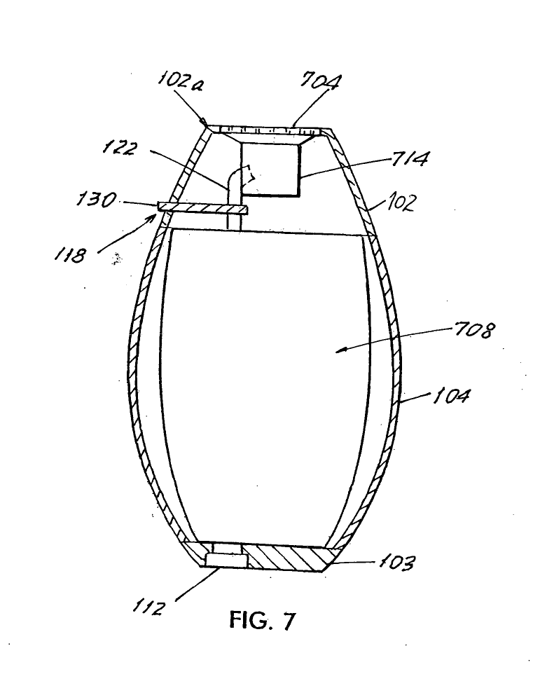

Referring now to FIGS. 1G and 1H, which show an isolated view of flow control mechanism 118a in an open and closed position, respectively, and to FIG. 11, which shows a side view of flow control mechanisms 118a in a partially closed position, flow control mechanism 118a operates by rotating dial 130a such that notched edge 132a presses tube 122a against pressing block 134a. Accordingly, as notched edge 132a presses against tube 122a, the size of the opening/passage in the tube compresses, thereby decreasing the flow of a condiment through tube 122a. Note that flow control mechanism 118b and tube 122b operate in the same way. Preferably, dial 130a, and similarly dial 130b, is operable to compress tube 122a until the opening in the tube is completely shut, thereby sealing off condiment chamber 108a from discharge chamber 114. Similarly, as dial 130a is rotated so as to move notched edge 132a away from pressing block 134a, tube 122a decompresses, thereby causing the size of the tube opening to increase back towards its original size and thereby increasing the flow of a condiment through tube 122a (as indicated, tubes 122a and 122b are preferably formed from an elastic and flexible material).

According to an example embodiment of the invention, dials 130a and 130b for each flow control mechanism 118a and 118b are configured to resistively rotate, for example, so that each dial can be individually moved to any flow position and thereafter retain that position. In this way, a user can individually configure each flow control mechanism 118a and 118b to a desired setting and then dispense the condiments without the difficulty of trying to maintain the setting. Similarly, a user can individually configure each flow control mechanism 118a and 118b to a desired setting and have each mechanism retains its respective setting between uses. Nonetheless, one skilled in the art will recognize that dials 130a and 130b may be configured in alternate fashions. For example, a separate spring may be coupled to each dial 130a and 130b, thereby forcing each dial 130a and 130b to move to a fully closed or fully open position once a user stops manipulating the dial.

Note that while each flow control mechanism 118a and 118bis described above as a rotational dial with a notched edge, any type of rotational mechanism that compresses and decompresses tubes 122a and 122b can be used. Furthermore, flow control mechanisms 118a and 118b do not need to be a rotational mechanism. For example, each mechanism 118a and 118b may be a spring-activated button, or the like, that when pressed, compresses tube 122a or tube 122b and that decompresses the tube when released.

According to an example embodiment of the present invention, because condiments flow through tubes 122a and 122b, the condiments never contact flow control mechanisms 118a and 118b. As result, the condiments are not able to collect upon the flow control mechanisms and interfere with the operation of the mechanisms.

Referring now to dispensing outlet 116 of discharge chamber 114, as described above and as shown in FIG. 1E, for example, the perimeter of discharge chamber 114 at top side (top end) 114c forms the open dispensing outlet 116. As indicated, discharge chamber 114 may have a cylindrical shape, thereby giving dispensing outlet 116 a circular shape. Nonetheless, discharge chamber 114 and dispensing outlet 116 are not restricted to these shapes, as described above.

According to an example embodiment of the present invention, the size of dispensing outlet 116, as formed by discharge chamber 114 at top side 114c, is such that condiments do not readily adhere to and thereby clog the outlet as is typically the case when small perforations are used. In addition, while dispensing outlet 116 is illustrated and described as being a single opening, discharge chamber 114 at top side 114c may be partitioned into two or more openings that together form dispensing outlet 116. Again, according to an example embodiment of the present invention, the size of each opening is preferably such that condiments do not readily adhere to and thereby clog the openings.

Referring now to dispersing element 120, according to an embodiment of the invention and as described above, this element may be a disc or plate that is positioned at a spaced distance above and over the top side 114c of discharge chamber 114, for example, and preferably extends beyond the perimeter/edge of the discharge chamber at top side 114c, as shown in FIG. 1A. In this way, the perimeter of discharge chamber 114 at top side 114c and the underside of dispersing element 120 form a gapped opening/outlet (or dispensing gap) 140 through which condiments are dispensed once exiting from the discharge chamber through dispensing gap 116. In addition and as shown in FIGS. 1A and 1B, dispersing element 120 may also be positioned relative to opening 105 to form a gap 105a, for example, through which condiments are dispensed from condiment dispenser 100 once passing through dispensing gap 140. Preferably, the size of gap 105a and dispensing gap 140 are such that condiments do not readily adhere to opening 105, discharge chamber 114, and dispersing element 120, thereby clogging the condiment dispenser.

As described above, dispersing element 120 operates to control the rate at which condiments are dispensed from the discharge chamber, through dispensing gap 116, and subsequently through opening 105. In addition, by having dispersing element 120 extend beyond the edge of discharge chamber 114, the dispersing element also operates to cause the condiments to flow outward and around the dispersing element while exiting through opening 105. In this way, dispersing element 120 causes the condiments to disperse outward from condiment dispenser 100, assisting in the spreading of the condiments. As can be seen, according to an embodiment of the invention, condiment dispenser 100 avoids the use of perforations (which typically clog) in order to control the flow rate and spreading of condiments.

Notably, while dispersing element 120 is illustrated as having a circular shape, the dispersing element is not restricted to this shape. In addition, while dispersing element 120 is described as extending beyond the top side edge 114c of discharge chamber 114, dispersing element 120 may alternatively have a smaller diameter and extend up to the top side edge 114c of discharge chamber 114. As another alternative, dispersing element 120 may reside within discharge chamber 114. For example, assuming discharge chamber 114 is cylindrical, dispersing element may be a disc that has a diameter smaller than that of dispensing outlet 116. In this way, dispersing element 120 may reside within the plane of dispensing outlet 116, as partially shown in FIG. 1J for example, or may reside below the plane of dispensing outlet 116. In either case, dispersing element 120 continues to form a gap 140 between the perimeter of the dispersing element and the walls 114a of discharge chamber 114, controlling the rate at which condiments are dispensed from the condiment dispenser and helping to disperse the condiments.

In general, any mechanism known in the art for connecting dispersing element 120 to condiment dispenser 100 in order to obtain any of the above described configurations can be used. As an example and as illustrated in FIG. 1A, for example, dispersing element 120 may be connected to a column 136 and the column then connected to condiment dispenser 100. In particular, dispersing element 120 may be connected at the top side of column 136 (dispersing element 120 and column 136 may be two interconnected modules or a single integral module, for example). Column 136 in turn may be inserted through the center of discharge chamber 114, through a shaft in the center of partition 106d, for example, and screwed into base 103, for example. In this way, dispersing element 120 essentially floats in a stationary position relative to discharge chamber 114/dispensing outlet 116. In general, dispersing element 120 and column 136 can be formed from any suitable material known in the art, such as metal or plastic.

In general, one skilled in the art will recognize that condiment dispenser 100 is not limited to tubes 122a and 122b to interconnect the condiment chambers 108a/108b to the discharge chamber 114 and any mechanism known in the art for interconnecting the discharge chamber and condiment chambers may be used. In addition, condiment dispenser 100 is not limited to flow control mechanisms 118a and 118b and any mechanism known in the art for controlling the flow between the chambers may be used. Note further that condiment dispenser 100 does not need to include flow control mechanisms that control the flow of condiments between the condiment chambers and discharge chamber. Referring now to FIGS. 2A and 2B, there is illustrated an example condiment dispenser 200 according to an example embodiment of the invention. Note that FIG. 2A shows a side view of the condiment dispenser with a portion of cap 102 removed and FIG. 2B shows a cross sectional top view of dispenser 200. Condiment dispenser 200 substantially resembles condiment dispenser 100, for example, and includes multiple condiment chambers, such as chambers 108a and 108b, a discharge chamber 214 (shown in cross section in FIG. 2A), a dispensing outlet 216 within the top side of the discharge chamber, a dispersing element 120, and a dispensing gap 140. However, according to this embodiment of the invention, an alternative mechanism for interconnecting the condiment chambers and discharge chamber is used and an alternative flow control mechanism is used.

Specifically, as shown in FIGS. 2A and 2B, the bottom wall 214b of discharge chamber 214 is now positioned over the top wall 106b of chamber 106. To interconnect discharge chamber 214 to condiment chambers 108a and 108b, two holes/openings 202a and 202b may be formed within bottom wall 214b of discharge chamber 214 and two holes/openings 204a and 204b may be formed within top wall 106b of chamber 106, each set of holes corresponding to a respective condiment chamber 108a and 108b. Discharge chamber 214 and condiment chambers 108a and 108b are positioned such that openings 202a and 202b reside over openings 204a and 204b, respectively, thereby forming connected paths between discharge chamber 114 and condiment chamber 108a and 108b.

To control the flow between the condiment chambers and discharge chamber, one or more rotational dials such as dials 206a/206b, for example, with openings 208a/208b formed therein may be positioned horizontally within condiment dispenser 200, with dial 206a positioned between discharge chamber 214 and condiment chamber 108a and with dial 206b positioned between discharge chamber 214 and condiment chamber 108b. Each dial 206a/206b may be configured to rotate and preferably extends beyond cover 102 such that a user may manually move/rotate the dial. To control the flow between condiment chamber 108a and discharge chamber 214, dial 206a may be rotated such that opening 208a moves into and out of alignment with openings 202a and 204a, varying the size of the connected path and possibly closing off the path. Dial 206b may be similarly operated. Notably, rather than rotating dials, the flow control mechanisms may include one or more sliding plates with openings/holes formed therein that are situated between condiment chambers 108a/108b and discharge chamber 214. Here, assuming two plates are used, the sliding of each plate may move the hole formed therein into and out of alignment with openings 202a/204a and openings 202b/204b.

Referring now to FIG. 3, there is shown a cross sectional side view of an example condiment dispenser 300 according to another example embodiment of the invention. As described above, condiment dispenser 100 includes a single discharge chamber 114 with a corresponding dispensing outlet 116 through which condiments from both condiment chambers 108a and 108b are dispensed towards opening 105. According to this example embodiment of the invention, each condiment chamber 108a and 108b has a corresponding/dedicated discharge chamber.

For example, as illustrated in FIG. 3, condiment dispenser 300 includes multiple discharge chambers 314a and 314b, with discharge chamber 314a corresponding to condiment chamber 108a and discharge chamber 314b corresponding to condiment chamber 108b. Discharge chambers 314a and 314b each substantially resembles discharge chamber 114. The flow control mechanisms (although none are required) and the interconnection between condiment chambers 108a and 108b and discharge chambers 314a and 314b, respectively, may resemble that of condiment dispenser 100, may resemble that condiment dispenser 200, or may be any other mechanism known in the art for interconnecting the chambers and for controlling the flow between the chambers. As an example, an interconnection and flow control mechanism similar to that of condiment dispenser 100 is illustrated in FIG. 3. Here, tube 122a connects condiment chamber 108a to discharge chamber 314a and tube 122b connects condiment chamber 108b to discharge chamber 314b. Rotary dial 130a, for example, controls the flow through tube 122a and rotary dial 130b, for example, controls the flow through tube 122b similar to condiment dispenser 100.

Similar to discharge chamber 114, each discharge chamber 314a and 314b has a dispensing outlet 316a/316b of one or more openings at the top side of the chamber. Dispersing elements 320a and 320b, each of which resembles dispersing element 120, are respectively positioned at a spaced distance above and over, for example, each dispensing outlet. The top side edge of discharge chambers 314a and 314b and the underside of dispersing elements 320a and 320b, for example, each forms a dispensing gap 340a and 340b, each of which is similar to dispensing gap 140. Similar to condiment dispenser 100, a respective condiment is dispensed from a respective discharge chamber 314a/314b, through a respective dispensing gap 340a/340b, around a respective dispersing element 320a/320b, and then through an opening at the top side of lid 102. Note that lid 102 may have a single opening at the top side (similar to dispenser 100) in which is positioned each dispersing element 320a and 320b . Alternatively, as shown in FIG. 3, lid 102 may have two openings 105c and 105d, for example, each of which may have a respective dispersing element positioned therein, for example. As an example and as illustrated in FIG. 3, dispersing elements 320a and 320b may be connected to columns 336a and 336b, respectively, and each column then screwed into base 103, for example.

As another example, condiment dispenser 300 may include a single discharge chamber that is subdivided into two separate chambers, one for each condiment chamber, with each discharge chamber having a corresponding dispensing outlet of one or more openings. Here, condiment dispenser 300 may further include only one dispersing element that is positioned at a spaced distance above both dispensing outlets and that forms a dispensing gap with each dispensing outlet.

Referring now to FIG. 4, there is shown a cross sectional side view of an example condiment dispenser 400 according to another example embodiment of the invention. As described above, condiment dispenser 100 includes multiple condiment chambers, each for storing a condiment. According to this example embodiment of the invention, condiment dispenser 400 may include a single condiment chamber 408 for holding a single condiment. For example, as illustrated in FIG. 4, condiment dispenser 400 may include a discharge chamber 414 and a dispersing element 120 connected to a column 136. The dispersing element 120 may be positioned within an opening 105, for example, and over a dispensing outlet 416 within discharge chamber 414, for example, thereby forming a dispensing gap 140 with the discharge chamber, similar to condiment dispenser 100. Condiment dispenser 400 may also include a single condiment chamber 408 for storing a condiment. The flow control mechanism (although none is required) and the interconnection between condiment chamber 408 and discharge chamber 414 may resemble that of condiment dispenser 100, may resemble that of condiment dispenser 200, or may be any other mechanism known in the art for interconnecting the chambers and for controlling the flow between the chambers. As an example, an interconnection and flow control mechanism similar to that of condiment dispenser 100 is shown in FIG. 4. Here, tube 122 connects condiment chamber 408 to discharge chamber 414 and rotary dial 130, for example, controls the flow through tube 122 similar to condiment dispenser 100.

Referring now to FIGS. 5A and 5B, there is illustrated an example condiment dispenser 500 according to another example embodiment of the invention. Note that FIG. 5A shows a cross sectional side view of dispenser 500, with a portion of case 104, cover 102, and base 103 removed and FIG. 5B shows a top view of the dispenser. Condiment dispenser 500 is similar to condiment dispenser 100, for example, and includes one or more condiment chambers 108a and 108b, a discharge chamber 514 that is similar to discharge chamber 114, tubes 122a/122b that interconnect the condiment chambers 108a/108b to the discharge chamber 514, and flow control mechanisms 118a and 118b, such as rotary dials 130a/130b, that compress tubes 122a/122b to vary the size of the tube openings, as described above for condiment dispenser 100. Condiment dispenser 500, however, does not include a dispersing element 120 positioned over a discharge chamber 514 to control the dispensing and dispersing of condiments. Rather, according to this example embodiment of the invention, any mechanism known in the art for dispensing and dispersing the condiments from the condiment dispenser may be used. For example, as illustrated in FIGS. 5A and 5B, discharge chamber 514 may be open along its top side, thereby forming a dispensing outlet 516, as similarly described for discharge chamber 114. In addition, the discharge chamber may extend towards the top side 102a of lid 102. A cover 504, for example, with a plurality of perforations 502 formed therein may be disposed within the top side 102a of lid 102 over discharge chamber 514/dispensing outlet 516. In this way, as condiments leave discharge chamber 514 through dispensing outlet 516, the condiments pass through perforations 502, which control the dispensing/dispersing of the condiments in the normal fashion.

Referring now to FIG. 6, there is shown a cross sectional side view of an example condiment dispenser 600 according to another example embodiment of the invention. Condiment dispenser 600 is substantially similar to condiment dispenser 500, for example. However, rather than having a single discharge chamber that is connected to both condiment chambers 108a/108b, each condiment chamber 108a and 108b now has a corresponding/dedicated discharge chamber.

For example, as illustrated in FIG. 6, condiment dispenser 600 may include multiple discharge chambers 614a and 614b, each of which substantially resembles discharge chamber 514, for example, with discharge chamber 614a corresponding to condiment chamber 108a and discharge chamber 614b corresponding to condiment chamber 108b. Tube 122a connects condiment chamber 108a to discharge chamber 614a with flow control mechanism 118a, such as a rotary dial 130a, controlling the flow through this tube, as similarly described for condiment dispenser 100. Similarly, tube 122b connects condiment chamber 108b to discharge chamber 614b with flow control mechanism 118b, such as a rotary dial 130b, controlling the flow through this tube.

Similar to condiment dispenser 500, any mechanism known in the art for dispensing and dispersing the condiments from discharge chambers 614a and 614b may be used. For example, as shown in FIG. 6, covers 604a and 604b, each with a plurality of perforations 602 formed therein, may be disposed within the top side 102a of lid 102, each over a respective discharge chamber 614a and 614b for the dispensing/dispersing of condiments. Alternatively, lid 102 may have a single perforated cover that extends over both discharge chambers.

As another example, condiment dispenser 600 may include one discharge chamber that is subdivided into two separate chambers, one for each condiment chamber. Again, any mechanism known in the art for dispensing and dispersing the condiments from the discharge chambers may be used.

Referring now to FIG. 7, there is shown a cross sectional side view of an example condiment dispenser 700 according to another example embodiment of the invention. Condiment dispenser 700 is substantially similar to condiment dispenser 500, for example. Rather than having multiple condiment chambers, however, condiment dispenser 700 includes single condiment chamber 708 for holding a single condiment, for example. Tube 122 interconnects condiment chamber 714 to discharge chamber 708 and flow control mechanism 118, such as a rotary dial 130, compresses tube 122 to vary the size of the tube opening, as similarly described for condiment dispenser 100. Similar to condiment dispenser 500, any mechanism known in the art for dispensing and dispersing the condiments from discharge chamber 714 may be used, such as a perforated cover 704 disposed within top side 102a of lid 102 over the discharge chamber.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A condiment dispenser for holding condiments comprising:
a first end having an outlet;
a plurality of condiment chambers for storing the condiments, wherein each of said plurality of condiment chambers is in communication with said outlet such that the condiments in said plurality of chambers are dispensed through said outlet; and
a dispersing element in a path of said outlet and positioned such that condiments dispensed through said outlet deflect and disperse around said dispersing element.

2. The condiment dispenser of claim 1, further comprising a plurality of flow control mechanisms each corresponding to one of said plurality of condiment chambers and for controlling a flow of the condiment from said corresponding condiment chamber towards said outlet.

3. The condiment dispenser of claim 2, wherein each of said flow control mechanisms is independently operable to move between a plurality of positions and to retain any of said plurality of positions.

4. The condiment dispenser of claim 1, further comprising a plurality of tubes each with first and second ends, wherein each of said plurality of tubes is connected at the first end to one of said plurality of condiment chambers and is in communication with said outlet at the second end, and wherein the condiments in said plurality of condiment chambers are dispensed through said plurality of tubes towards said outlet.

5. The condiment dispenser of claim 4, further comprising a plurality of flow control mechanisms each corresponding to one of said plurality of condiment chambers, wherein each of said plurality of flow control mechanisms is operable to vary in size an opening of said tube connected to said corresponding condiment chamber.

6. The condiment dispenser of claim 5, further comprising a discharge chamber forming said outlet, wherein each of said plurality of tubes is connected at the second end to said discharge chamber.

7. The condiment dispenser of claim 5, wherein each of said flow control mechanisms is independently operable to move between a plurality of positions and to retain any of said plurality of positions.

8. The condiment dispenser of claim 1, wherein said dispersing element is at a spaced distance from a perimeter of said outlet and forms with said perimeter a gapped outlet through which the condiments are dispensed.

9. A condiment dispenser for holding condiments comprising:
an open discharge chamber;
a dispersing element positioned respective to said open discharge chamber to form therewith a gapped outlet for dispensing the condiments; and
a plurality of condiment chambers for storing the condiments, wherein each of said plurality of condiment chambers is in communication with said discharge chamber such that the condiments in said plurality of chambers are dispensed through said gapped outlet.

10. The condiment dispenser of claim 9, further comprising a plurality of flow control mechanisms each corresponding to one of said plurality of condiment chambers and for controlling a flow of the condiment from said corresponding condiment chamber towards said gapped outlet.

11. The condiment dispenser of claim 9, further comprising a plurality of tubes each with first and second ends, wherein each of said plurality of tubes is connected at the first end to one of said plurality of condiment chambers and is connected at the second end to said discharge chamber, and wherein the condiments in said plurality of condiment chambers are dispensed through said plurality of tubes towards said gapped outlet.

12. The condiment dispenser of claim 11, further comprising a plurality of flow control mechanisms each corresponding to one of said plurality of condiment chambers, wherein each of said plurality of flow control mechanisms is operable to vary in size an opening of said tube connected to said corresponding condiment chamber.

13. The condiment dispenser of claim 12, wherein each of said flow control mechanisms is independently operable to move between a plurality of positions and to retain any of said plurality of positions.

14. The condiment dispenser of claim 9, wherein said dispersing element is at a spaced distance from a perimeter of said open discharge chamber thereby forming said gapped outlet.

15. A condiment dispenser comprising:
a discharge chamber forming an outlet;
a condiment chamber for storing a condiment, wherein said condiment chamber is in communication with said discharge chamber such that the condiment in said condiment chamber is dispensed through said outlet; and
a stationary dispersing element in a path of said outlet and positioned such that the condiment dispensed through said outlet deflects and disperses around said dispersing element.

16. The condiment dispenser of claim 15, further comprising:
at least a second discharge chamber forming a second outlet; and
at least a second condiment chamber for storing a condiment, wherein said at least second condiment chamber is in communication with said at least second discharge chamber such that the condiment in said at least second condiment chamber is dispensed through said second outlet.

17. The condiment dispenser of claim 16, wherein said stationary dispersing element is at a spaced distance from a perimeter of said first outlet and forms with said perimeter a gapped outlet through which the condiment from said first condiment chamber is dispensed.

18. The condiment holder of claim 16, further comprising at least two flow control mechanisms, each corresponding to one of said condiment chambers and each controlling a flow of the condiment from its corresponding condiment chamber towards said discharge chamber with which said corresponding condiment chamber is in communication.

19. The condiment dispenser of claim 18, wherein each of said at least two flow control mechanisms is independently operable to move between a plurality of flow positions and to retain any of said flow positions.

20. The condiment dispenser of claim 16, further comprising at least two tubes each corresponding to one of said condiment chambers and each connecting its corresponding condiment chamber to said discharge chamber with which said corresponding condiment chamber is in communication.

21. The condiment dispenser of claim 15, further comprising a flow control mechanism for controlling a flow of the condiment from said condiment chamber towards said outlet.

22. The condiment dispenser of claim 15, further comprising a tube connecting said condiment chamber to said discharge chamber such that the condiment in said condiment chamber flows through said tube towards said discharge chamber.

23. The condiment dispenser of claim 22, further comprising a flow control mechanism operable to vary in size an opening of said tube thereby controlling a flow of the condiment from said condiment chamber towards said discharge chamber.

24. A condiment dispenser comprising:
a plurality of condiment chambers for storing condiments;
a first end having one or more openings for dispensing the condiments; and
a plurality of tubes each having first and second ends, wherein the first end of each of said plurality of tubes is connected to one of said plurality of condiment chambers, wherein the second end of each of said plurality of tubes is in communication with said one or more openings, and wherein the condiments in said plurality of condiment chambers flow through said plurality of tubes towards said one or more openings.

25. The condiment dispenser of claim 24, wherein each of said plurality of tubes is elastically flexible.

26. The condiment dispenser of claim 24, further comprising a plurality of flow control mechanisms each corresponding to one of said plurality of condiment chambers, wherein each of said plurality of flow control mechanisms is operable to vary in size an opening of said tube connected to said corresponding condiment chamber thereby controlling a flow through said tube.

27. The condiment dispenser of claim 26, wherein each of said flow control mechanisms varies in size the opening of said tube connected to said corresponding condiment chamber by compressing said tube.

28. The condiment dispenser of claim 26, wherein each of said flow control mechanisms is independently operable to move between a plurality of flow positions and to retain any of said plurality of flow positions.

29. The condiment dispenser of claim 24, further comprising at said first end a discharge chamber in communication with said one or more openings, wherein the second ends of each of said plurality of tubes are connected to said discharge chamber.

30. A condiment dispenser comprising:
a condiment chamber for storing a condiment;
a discharge chamber with one or more openings for dispensing the condiment; and
a tube connecting said condiment chamber to said discharge chamber such that the condiment in said condiment chamber is dispensed through said tube, towards said discharge chamber, and though said one or more openings.

31. The condiment dispenser of claim 30, further comprising:
at least a second condiment chamber for storing a condiment;
at least a second discharge chamber with one or more openings; and
at least a second tube connecting said at least second condiment chamber to said at least second discharge chamber such that the condiment in said least second condiment chamber is dispensed through said at least second tube, towards said at least second discharge chamber, and though said one or more openings of said at least second discharge chamber.

32. The condiment dispenser of claim 31, further comprising at least two flow control mechanisms, each corresponding to one of said condiment chambers and being operable to control a flow of the condiment from its corresponding condiment chamber by varying in size an opening of said tube connected to its corresponding condiment chamber.

33. The condiment dispenser of claim 32, wherein each of said at least two flow control mechanisms is independently operable to move between a plurality of flow positions and to retain any of said plurality of flow positions.

34. The condiment dispenser of claim 31, further comprising at least two dispersing elements, each corresponding to one of said discharge chambers and in a path of said one or more openings of its corresponding discharge chamber to deflect and disperse the condiment dispensed through said one or more openings.

35. The condiment dispenser of claim 30, further comprising a flow control mechanism that is operable to vary in size an opening of said tube, thereby controlling a flow of the condiment from said condiment chamber.

36. The condiment dispenser of claim 35, further comprising a dispersing element in a path of said one or more openings to deflect and disperse the condiment dispensed through said one or more openings.

37. A condiment dispenser comprising:
a first end having one or more outlets for dispensing condiments;
a plurality of condiment chambers for storing the condiments, wherein each of said plurality of condiment chambers is in communication with one of said one or more outlets;
a plurality of flow control mechanisms each corresponding to one of said plurality of condiment chambers and for controlling a flow of the condiment from its corresponding condiment chamber to said one outlet with which said corresponding condiment chamber is in communication; and
wherein each of said flow control mechanisms is independently operable to move between a plurality of flow positions and to retain any of said plurality of flow positions.

38. The condiment dispenser of claim 37, further comprising a plurality of tubes each corresponding to one of said plurality of condiment chambers and connecting its corresponding condiment chamber to said one outlet with which said corresponding condiment chamber is in communication.

39. The condiment dispenser of claim 37, further comprising a respective dispersing element corresponding to each one of said one or more outlets, each dispersing element being in a path of its corresponding outlet to deflect and disperse the condiments dispensed through its corresponding outlet.

40. A condiment dispenser for holding condiments comprising:
a discharge chamber forming an outlet;
a plurality of condiment chambers for storing the condiments;
a plurality of tubes each connecting one of said plurality of condiment chambers to said discharge chamber such that the condiments in said plurality of condiment chambers flow through said plurality of tubes towards said discharge chamber;
a plurality of flow control mechanisms each corresponding to one of said plurality of condiment chambers, wherein each of said plurality of flow control mechanisms is operable to vary in size an opening of said tube connected to said corresponding condiment chamber; and
a dispersing element in a path of said outlet to deflect and disperse condiments dispensed through said outlet.

41. The condiment dispenser of claim 40, wherein each of said flow control mechanisms is independently operable to move between a plurality of positions and to retain any of said plurality of positions.

42. The condiment dispenser of claim 40, wherein said dispersing element is at a spaced distance from a perimeter of said outlet and forms with said perimeter a gapped outlet through which the condiments are dispensed.

43. The condiment dispenser of claim 40, wherein each of said plurality of tubes is elastically flexible.

44. A method for dispensing condiments, comprising the steps of:
selecting one or more condiments from a condiment dispenser, said condiment dispenser comprising a plurality of condiment chambers for storing the condiments, a discharge chamber in communication with one or more openings, a plurality of tubes each connecting one of said plurality of condiment chambers to said discharge chamber such that the condiments flow through said plurality of tubes to said discharge chamber, and a plurality of flow control mechanisms each corresponding to one of said plurality of tubes and operable to control a rate of flow of the condiment through its corresponding tube;
configuring to a desired setting each flow control mechanism corresponding to said one or more selected condiments; and
moving said condiment dispenser such that said one or more selected condiments flow into said discharge chamber and are dispensed through said one or more openings.

45. The method of claim 44, wherein said condiment dispenser further comprises a dispersing element positioned respective to said one or more openings to form a gapped outlet for dispensing the condiments, and wherein said moving step causes said one or more selected condiments to be dispensed through said gapped outlet.
